(19) United States
(12) Patent Application Publication
(10) Pub. No.: US 2015/0172302 A1
(43) Pub. Date: Jun. 18, 2015

(54) INTERFACE FOR ANALYSIS OF MALICIOUS ACTIVITY ON A NETWORK

(71) Applicant: Vahna, Inc., Alexanderia, VA (US)

(72) Inventor: Brendan M. Conlon, Alexandria, VA (US)

(73) Assignee: Vahna, Inc., Alexanderia, VA (US)

(21) Appl. No.: 14/105,898

(22) Filed: Dec. 13, 2013

(51) Int. Cl. H04L 29/06

(52) U.S. Cl. CPC H04L 63/1408

(57) ABSTRACT

A system for analysis of disparate data sources provides the ability to discover advanced incidents of malicious activity on a network. The system includes a correlation engine that, in the event of a triggering alert, queries information from more than one source to correlate the existence of malicious activity. The sources of information may include a network intrusion detection system and agent software running on various host devices attached to a network.

### FIELD OF THE INVENTION

The present invention relates to telecommunications networks and the security of such networks. More particularly, the present invention relates to an interface for analysis of disparate data sources, providing the ability to discover advanced incidents of malicious activity on a network.

### BACKGROUND OF THE INVENTION

The nature of a distributed network, such as the Internet, makes it vulnerable to attack. The Internet was designed to allow for the freest possible exchange of information, data, and files. However, this free exchange of information carries a price: many users will try to attack the networks and computers connected to the internet; many users will also try to invade other users' privacy and attempt to crack databases of sensitive information or intercept information as it travels across internet routes.

To detect or prevent such computer attacks, intrusion detection systems and software programs that gather information and make changes to security configurations of network computers have been developed. However, these conventional intrusion detection systems can typically have many problems and drawbacks. Conventional intrusion detection systems typically comprise hardware that is dedicated to intrusion detection on networks. Other intrusion detection systems can simply comprise programs running on a host computer.

Within the enterprise cyber security realm, there is a significant gap in the ability to easily and efficiently fuse network-based and host-based intrusion information into a unified interface for analysis of, and response to, malicious cyber activity. Some tools provide the capability to analyze network layer information, and other tools provide the capability to analyze information collected from host based intrusion prevention systems. In addition, there are tools that collect information for automated detection across multiple datasets, but they do not provide a mechanism for analyzing the data. In addition there is no tool that provides the capability to take the information gained from that fusion, and enable a response at the appropriate level of the network.

Accordingly, there is a need for a system that can provide an interface for analysis of disparate data sources, providing the ability to discover advanced incidents of malicious activity on a network. This requires the collection, fusion, and correlation of information from multiple different sensors including host intrusion detection systems, network intrusion detection systems and system error logs from network devices. The need also exists for a system that provides the capability to take action at the various appliances (host, network, firewall, etc.).

### BRIEF DESCRIPTION OF THE PRIOR ART

U.S. Pat. No. 8,141,157 to Farley et al. discloses a method and system which manages computer security information in which multiple data sources such as sensors or detectors used in intrusion detection systems monitor data traffic. The information from the sensors is fused in a fusion engine to identify relationships between real time computer events and assess and rank the risk of real-time raw events and mature correlation events.

U.S. Pat. No. 7,712,133 to Raiker et al. discloses an integrated intrusion detection method in which information from a plurality of intrusion detector sensors is gathered and processed to provide a consolidated correlation of information. A severity is assigned to the information based on an enterprise wide security policy and a response is assigned and implemented in accordance with the severity.

U.S. Pat. No. 7,313,695 to Norton et al. discloses a system for dynamically assessing threats to computers and computer networks. Events from a plurality of security devices are analyzed to determine what combination of attacks coming from and going to various hosts would indicate that a larger coordinated attack is in progress. The security devices include network intrusion detection systems, host intrusion detection systems, routers, firewalls, and system loggers.

While the prior systems provide some useful functionality, they fail to provide an adequate ability to discover advanced incidents of malicious activity on a network and a capability to take action at various network appliances. Current tools focus on either network-based information, inspecting packets or sessions looking for communications of interest, or the tools focus on host-based information such as signatures of files or processes running on a host. There are currently no tools attempting to fuse and normalize information from these two types of sensors into one unified interface.

### SUMMARY OF THE INVENTION

Accordingly, it is a primary object of the invention to provide a system and interface for conducting incident response activities on an enterprise network. The invention includes a novel tool providing the ability to fuse collected information from network-based and host-based intrusion prevention systems into a single user interface for the purpose of performing intrusion analysis and incident response. In particular, the present invention takes data from multiple critical sources (host and network-based sensors), fuses that data together in a useful manner, and provides enhanced situational awareness within a network.

### BRIEF DESCRIPTION OF THE FIGURES

Other objects and advantages of the invention will become apparent from a study of the following specification when viewed in the light of the accompanying drawing, in which:

FIG. 1 is a network diagram showing a system in accordance with an embodiment of the present invention; and

FIG. 2 is a flow chart showing the response to a network event in accordance with an embodiment of the present invention.

### DETAILED DESCRIPTION

The present invention includes a set of integrated technologies that store and run a set of analytics against network-based and agent-provided information. The invention is capable of recognizing patterns based on both specific behaviors of interest as well as signatures of network traffic on interest. Through a set of defined software interfaces, the invention integrates into existing enterprise security products.

The invention takes structured and unstructured data inputs from various sensors and provides output to a user that aids in understanding situational awareness and suggests appropriate decisions. These decisions are derived from both hard coded decision logic as well as algorithms implemented within the invention.

Although the illustrative embodiment will be generally described in the context of program modules running on a personal computer and a server, those skilled in the art will recognize that the present invention may be implemented in conjunction with operating system programs or with other types of program modules for other types of computers. Furthermore, those skilled in the art will recognize that the present invention may be implemented in either a stand-alone or in a distributed computing environment or both. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general-purpose machines may be used with the program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

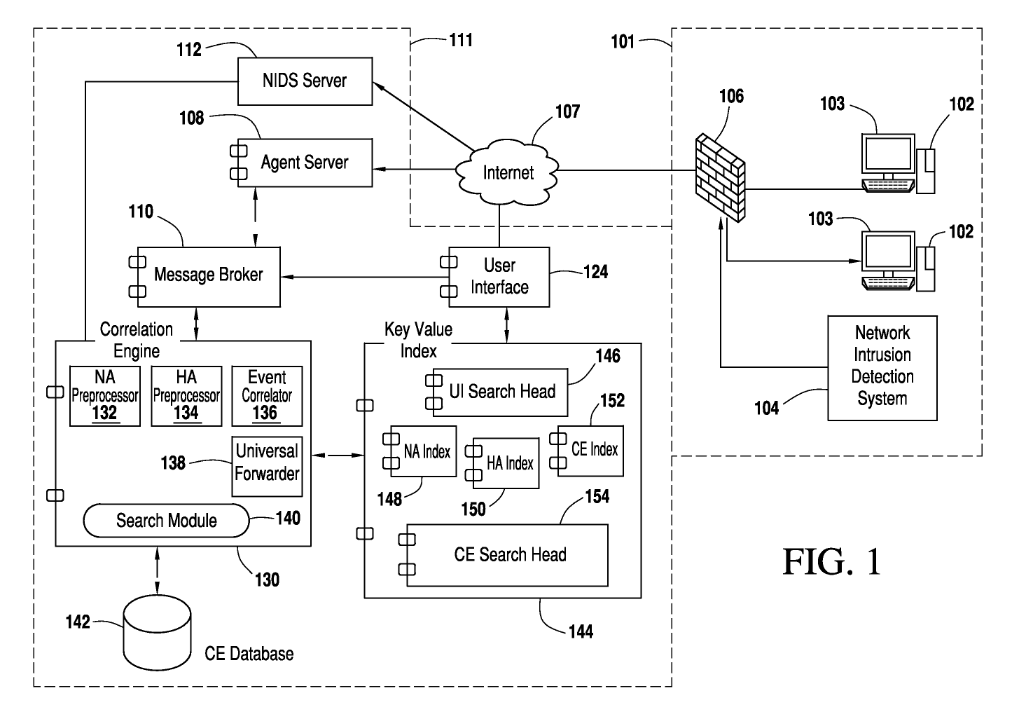

FIG. 1 shows a diagram of a system in accordance with the present invention. The system includes various components as will be described below.

A customer network 101 incorporates various components that are connected via a network. These components may be physically located at a single facility or may be located in geographically diverse locations. The customer network may include machines, terminals or hosts 102. These hosts are appliances or devices connected to the customer network 101 and may be any type of network appliance or terminal as would be know to one of ordinary skill in the art, including, but not limited to desktop personal computers, laptops, handheld devices, tablets, smartphones, servers, or the like. Each host 102 may be assigned an Internet protocol (IP) address.

The hosts 102 may include agent software 103 stored in non-volatile memory and executable by each host. The agent software may include a virus scanner, a terminal activity log, along with other software functions and information stored in memory by the host 102.

The customer network 101 may also include a network intrusion detection system (NIDS) 104. The NIDS may comprise a purpose built networked appliance or may comprise a general purpose personal computer or server programmed with software containing specific instructions and stored at least in part in non-volatile memory. By way of example, the NIDS may comprise Snort®, an open source network intrusion prevention and detection system developed by Sourcefire, Inc. The NIDS 104 may include a system log that stores information regarding network traffic and other parameters in memory on the device executing the NIDS software. The NIDS 104 may provide a database for storage of this information as well as a user interface and other functions.

The customer network 101 may also include additional hosts, computers, servers and other devices that are not shown and may be made up of one or more local area networks (LAN) or wide area networks (WAN). The customer network may be connected to the Internet 107. A firewall 106 may be used to control incoming and outgoing network traffic between the customer network 101 and the Internet 107 or some other WAN.

A system in accordance with the present invention may also include a provider network 111. The provider network may include a variety of machines or terminals. These machines may be physically co-located or may be located in geographically diverse locations and connected by a LAN, WAN or the Internet. The connections illustrated in FIG. 1 are illustrative only, and it should be understood that any appropriate network or arrangement of connections could be used as would be understood by one of ordinary skill in the art.

The provider network may comprise an agent server 108. The agent server 108 provides command and control for the agents 103.

The provider network 111 may also include one or more user interfaces 124 to allow a user to interact with the software and machines that comprise the provider network.

The provider network 111 may further comprise a message broker 110 that may be an open source message broker that implements the Advanced Messaging and Queuing Protocol (AMQP). An exchange server of the message broker 110 hosts a correlation engine exchange. The correlation engine exchange hosts several queues, including task queues for event processing. Upon receiving a message with a supported routing key, the exchange routes the event to the appropriate task queue. Each message is acknowledged and written to disk such that it can be republished should the server or worker go offline.

The provider network may also include a correlation engine 130 that processes Network Appliance (NA) alerts/logs and Host Agent (HA) instrumentation data to detect malicious activity. The correlation engine 130 generates alerts in response to various situations detected, including the following instances: (1) NA alert/log data is indicative of malicious activity; (2) HA system artifacts are indicative of malicious activity; or (3) both NA and HA data are indicative of malicious activity.

As an event processing entity, the correlation engine 130 uses various system attributes based on their ability to detect anomalies. Machine learning techniques are used to train the engine to produce an output indicating whether there is activity emblematic of malware on the system. Attributes may be measured at standard usage exploitation, infection, exfiltration, and destruction times. Information gain is calculated and those attributes rated highest are used as features in a classification algorithm like Random Forest or Naive Bayes. Receiver Operating Characteristic (ROC) analysis is used to evaluate the costs of misclassification errors and project the true positive and false positive rates. Attributes include but are not limited to:
Process Central Processing Unit (CPU) Affinity
Process CPU Percentage
Process CPU User/System Mode Time
Process Priority
Process Input Output (I/O) Priority
Process Context Switches
Process Number of Handles
Process Number of Threads
Process File Descriptors
Process Connection Local Port
Process Connection Remote Port
Process Memory Info: Resident Set, Virtual Memory, Extended, Percentage
Process I/O Counters: Read Count, Write Count, Read Bytes, Write Bytes
Process Mapped Memory Regions: Path and Resident Set Size
Process Open Files: Path and File descriptor

The correlation engine will also use hard coded logic to examine the below for more evidence of malicious activity.
Process Parent-Child Relationship
Process Username
Process Group IDs
Process Current Working Directory
Process Terminal
Process Command Line
Process Module Name
Process Connection Local Interface
Process Connection Remote IP
Process Creation Time
Process Status
Network Appliance Historical Data
   Each anomaly is weighted based on its presumed significance in the likelihood of infection.

The weighted average of HA/NA event attributes is used to determine event severity: low, medium, or high. As the volume of HA data is greater, its weight distribution may be given a greater weight, for example 60% in certain embodiments. Several iterations of inspection, to include on demand requests for additional data, are performed to determine alert necessity and severity.

The correlation engine 130 comprises a number of components, including a network appliance alert preprocessor 132, a host agent alert preprocessor 134, an event correlator 136, a universal forwarder 138 and a search module 140. The correlation engine 130 communicates with a correlation engine database 142.

In addition, the provider network may include a NIDS server 112 that receives alerts from the NIDS 104 and formats the information received for use by the correlation engine 130.

A message broker 110 associated with the provider network may be used to marshal events to the appropriate tasking queue. Processed events are forwarded to a key/value based search engine module 140 for machine-generated data, and thus made available for future correlation engine or client operator analysis.

The provider network 111 may also include key/value index 144 or other software/hardware that captures, indexes and correlates real-time data in a searchable repository from which it can generate datasets, graphs, reports, alerts, dashboards and visualizations. The index 144 may include a search head 146, network appliance index 148, host agent index 150, correlation engine index 152, correlation engine search head 154. By way of example, the index may be comprise Splunk software and associated hardware as developed by Splunk, Inc.

In addition, the provider network 111 may include a database 142. The database 142 may reside on one or more servers connected to the provider network or may comprise cloud based data storage for collection and analysis of data.

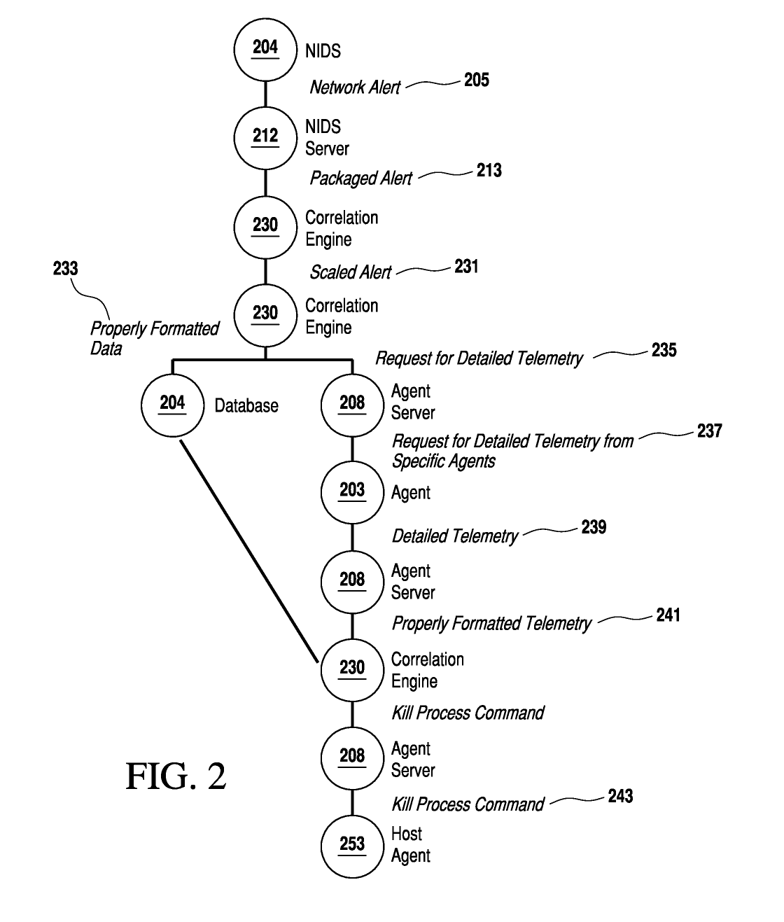

FIG. 2 illustrates a process flow in response to a network event in accordance with an embodiment of the present invention. In a first step, a NIDS 204 on a customer's network detects malicious traffic between an IP address on the customer's network and some external entity. The NIDS 204 then sends an alert 205 with the appropriate information to a NIDS Server 212 on a provider network. The NIDS Server 212 formats the alert, and sends it as a packaged alert 213 to a correlation engine (CE) 230 via a message broker.

The CE 230 scales the alert to remove the chance of false positives and creates a scaled alert 231. The CE 230 may then determine that it requires more information to appropriately respond to the threat. At this point, the CE 230 takes two actions. First, it inserts the properly formatted data 233 of the alert into a database 242 for auditing and analysis purposes. Second, the correlation engine sends a request for detailed telemetry 235 that tasks an Agent Server 208 with gathering more information.

The agent server 208 determines which agents 203 can retrieve the appropriate information. The agent server 208 tasks the appropriate agent 203 with collecting the requisite information by sending a request for detailed telemetry from specific agents 237.

The agent 203 receives the request 237, collects the information and responds to the agent server 208 with detailed telemetry 239. The agent server 208 passes this properly formatted telemetry information 241 to the correlation engine 230, which combines the information in the database 242 with the telemetry 241 received from the agent server 208 to make a determination whether to stop a process on one of the hosts that has an agent 203 installed. If the correlation engine 230 determines that the process should be stopped, the correlation engine 230 then tasks the agent server 208 with killing the named process. The agent server 208 in turn sends a kill process command 243, tasking the agent 203 with killing the process.

While the preferred forms and embodiments of the invention have been illustrated and described, it will be apparent to those of ordinary skill in the art that various changes and modifications may be made without deviating from the inventive concepts set forth above.

What is claimed is:

1. A process for detecting malicious activity on a network, comprising the steps of
(a) a network intrusion detection system server receiving an alert in response to a network intrusion detection system detecting potentially malicious traffic directed to a device connected to a network;
(b) the network intrusion detection system server transmitting information indicating that an alert has been received to a correlation engine;
(c) the correlation engine determining that more information is required;
(d) the correlation engine transmitting a request for additional information;
(e) the correlation engine receiving additional information in response to the request; and
(f) the correlation engine determining that a process operating on the device connected to the network should be terminated based at least in part on the additional information received.

2. A process as defined in claim 1, wherein the information indicating that an alert has been received comprises a packaged alert.

3. A process as defined in claim 2, and further comprising the step of the network intrusion detection system server transmitting the packaged alert to the correlation engine via a message broker.

4. A process as defined in claim 3, and further comprising the step of the correlation engine scaling the alert received from the network intrusion detection system server.

5. A process as defined in claim 1, and further comprising the step of an agent server receiving the request for additional information and transmitting it to an agent operating in conjunction with the device connected to a network.

6. A process as defined in claim 5, wherein the request for additional information comprises a request for detailed telemetry.

7. A process as defined in claim 1, and further comprising the step of the correlation engine inserting data relating to the alert into a database.

8. A process as defined in claim 1, and further comprising the step of the correlation engine transmitting instructions to terminate the process operating on the device connect to the network.

9. A process as defined in claim 8, and further comprising the step of the correlation engine transmitting instructions to the agent server to terminate the process operating on the device connect to the network.

10. A process as defined in claim 9, and further comprising the step of the agent server transmitting instructions to the agent operating in conjunction with the device connected to a network to terminate the process operating on the device connect to the network.

11. A system to detect malicious activity on a network with which a device is connected, comprising
(a) a network intrusion detection system server connected with the network for receiving an alert in response to a network intrusion detection system detecting potentially malicious traffic directed to the device;
(b) a correlation engine connected with said network intrusion detection system server for requesting additional information from the device in response to the alert; communicating with agent software that is executed by the device;
(c) an agent server connected with said correlation engine for communicating with agent software that is executed by the device; and
(d) a database connected with said agent server for collecting data.

12. A system as defined in claim 11, and further comprising a message broker connected between said agent server and said correlation engine.

13. A system as defined in claim 12, wherein said message broker comprises an open source message broker that implements an advanced messaging and queuing protocol.

14. A system as defined in claim 11, wherein said correlation engine comprises a search engine module.

15. A system as defined in claim 14, wherein said correlation engine includes a correlation engine database that stores information collected in response to a request for additional information from the device.

16. A system as defined in claim 11, wherein said database comprises a database of information collected at a predetermined periodicity.
